(19) United States
(12) Patent Application Publication
(10) Pub. No.: US 2009/0313599 A1
(43) Pub. Date: Dec. 17, 2009

(54) Method for handling cross-cutting concerns at business level

(75) Inventors: Shyam Kumar Doddavula, Bangalore (IN); Jatadhari K. Sharma, Bangalore (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Limited, Bangalore (IN)

(21) Appl. No.: 12/319,368

(22) Filed: Jan. 6, 2009

(30) Foreign Application Priority Data
Jan. 7, 2008 (IN) 52/CHE/2008

(51) Int. Cl. G06F 9/44

(52) U.S. Cl. 717/102

(57) ABSTRACT

A method for handling cross-cutting concerns at business level while developing enterprise application is disclosed. The method identifies the common variation requirements for the common cross cutting business concerns. The method then identifies the architecture strategies to enable identified variations and based on those strategies define an architecture with well defined variation points and finally define mechanisms for bundling such variations. The proposed solution describes how business aspects can be developed for applying cross cutting business concerns using the Infosys RADIEN Framework.

### BACKGROUND OF THE INVENTION

The invention relates generally to handling cross-cutting concerns at business level while developing enterprise business application, and more particularly to creating context aware enterprise business applications through managed variations.

A common requirement while developing enterprise applications is to support variations in the behavior of the applications based on factors like customer segment, delivery channel, user location, line of business (LOB) where the application is deployed etc.

For example in the insurance domain, the insurance calculations usually vary based on the state, country etc and similarly the steps in business processes like the insurance application processing, claims processing etc are typically different for different lines of business like for say property insurance, auto insurance etc. Similarly the interface applications and their behavior are different for different marketing channels like self service, assisted, retail, wholesale, partner etc. Until a few years ago, these requirements used to be addressed by developing separate applications in silos for the different LOBs, marketing channels, locations etc.

Traditional strategies for addressing these requirements have been to develop multiple applications/systems for different LOBs, Marketing Channels, Geographies etc. The problem with this approach is that it results in creation of silos of applications/systems with the impact that there is no seamless flow of information across the enterprise. This strategy also results in duplication of the applications and business processes resulting in inconsistencies and thus bad end user experience. This strategy also results in rigid IT systems resulting in high Time to Market and so lost business opportunities.

Other alternative is to develop one application that addresses the requirements of all contexts applying techniques like SOA, Object Orientation etc. The limitation of this approach is that the variations for the various contexts are interspersed across various locations of the application implementation resulting in spaghetti of variations. This makes the application fragile and also makes it hard to analyze what has been varied for a context to make any further variations as needed.

Presently Aspect Orientation techniques have been applied at programming level through AOP (Aspect Oriented Programming) and frameworks like AspectJ. Existing AOP techniques and frameworks like AspectJ are designed for handling cross cutting concerns at object level like enabling extra processing before and after a method execution by providing mechanisms (called PointCuts) like Before & After Method PointCuts. The problem with this is, these PointCuts are too fine grained and can't be used to express cross cutting concerns that make sense at business level.

The industry is moving towards a Service Oriented Architecture (SOA) to address these problems. So, instead of creating monolithic silos of applications, enterprises are increasingly looking at developing the required IT capabilities as Services that are then composed to create the required applications for the different LOBs, Channels, and Geographies etc.

Services are used in multiple business contexts like in different LOBs, different marketing channels and across multiple geographies. So, there is a need for variations to enable them to operate in these different contexts. One of the limitations with the current SOA strategies of several enterprises is that they lack a well defined solution for managing these variations. The variations are interspersed so much that they quickly become unmanageable.

Thus there was a need for better strategy to look at these requirements for variations based on usage context like LOBs, Channels, and Geographies etc as cross cutting business concerns and accordingly define strategies for architecting enterprise applications with well defined mechanisms for handling the variations for these concerns. In the non technical terms—“The IT architecture strategy should enable creating multiple Operating Contexts for the enterprise through managed variations”.

### BRIEF SUMMARY OF THE INVENTION

In one embodiment of the present technique, a method for handling multi business concern or cross-cutting concerns at a business level while developing enterprise application is disclosed. The inventive method identifies the various variation points and variations at the various architectural layers of a typical business application. The method also identifies the decision parameter that determines the usage context and accordingly the variations needed for the cross-cutting or multi business concern.

The inventive method identifies the common variation requirements for the common cross-cutting business concerns, then identifies the architecture strategies to enable such variations and then, based on those strategies define an architecture with well defined variation points and finally defines mechanisms for bundling such variations as a group to enable better management. The method also defines the mechanisms for associating the variation bundles to the usage contexts that will enable contextualizing the enterprise application characteristics to different operating contexts. The method also defines the mechanisms for determination and propagation of context across the various architectural layers of the enterprise application implicitly and injecting the variations based on the context and the configuration of the variation bundles to the contexts.

In another embodiment of the present technique, it is described how to take this inventive method to execution level by explaining how to develop a business aspects framework. The method enables developing context aware business enterprise applications.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an recommended logical architecture for the Business Logic Layer in an enterprise application framework with the business logic layer architectural variation mechanisms, in one embodiment of the present technique;

FIG. 2 is an recommended logical architecture for the User Interface (UI) Layer in an enterprise application framework with the UI layer architectural variation mechanisms, in one embodiment of the present technique;

FIG. 3 is an recommended logical architecture for the Integration Layer in an enterprise application framework with the integration layer architectural variation mechanisms, in one embodiment of the present technique;

FIG. 4 is an recommended logical architecture for the Data Layer with the Data Layer architectural variation mechanisms in an enterprise application framework, in one embodiment of the present technique;

FIG. 5 is an UML Model showing the Service Framework components, in one embodiment of the present technique;

FIG. 6 is an UML Model showing the various design elements of the architecture for a sample AccountService, in one embodiment of the present technique;

FIG. 7 is an UML Model showing the core business logic layer which is implemented using an Object Oriented Domain Model layer, in one embodiment of the present technique;

FIG. 8 is an UML Model showing the Business Aspects Framework with key design elements for Context and Variations management along with a few illustrative architectural variations components at some architectural layers, in one embodiment of the present technique; and

FIG. 9 is a system illustrating a generalized computer network arrangement, in one embodiment of the present technique.

### DETAILED DESCRIPTION

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As a preliminary matter, the definition of the term “or” for the purpose of the following discussion and the appended claims is intended to be an inclusive “or” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A” by itself, “B” by itself and any combination thereof, such as “AB” and/or “BA.” It is worth noting that the present discussion relates to exemplary embodiments, and the appended claims should not be limited to the embodiments discussed herein.

The present invention relates generally to handling cross-cutting concerns at business level while developing enterprise business application, and more particularly to creating context aware enterprise business applications through managed variations.

In one embodiment of the present technique, an inventive method is described for taking care of cross-cutting concerns that make sense at the business level while developing enterprise business applications through “Business Aspects”. It is also described how “business aspects” can be developed for applying cross-cutting business concerns using the Infosys Proprietary RADIEN Framework. And the method also enables creating context aware enterprise business applications through managed variations. Thus what is proposed—is a solution for creating coarse-grained aspects that will make sense at business level—which is called “Business Aspects” solution.

Following is the terminology which is used to describe the inventive method and explained the “Business Aspects” solutions.

“Context” can be defined as the combination of factors that sets the business operating and usage environment for a business application in an enterprise. It is defined in terms of parameters that influence business decisions, like Line of Business (LOB) in which the business application is being used, Geographical location of the organization providing the business service, the marketing channel (retail, wholesale, self-service etc) through which the business service is being provided, the delivery channel through which the service is being provided (internet, intranet, mobile etc) etc and external user factors like the user role (UI and access to functionality is sometimes dependent on the user role), the user geographical location, the time at which the service is used etc.

“Cross-Cutting Business Concern” can be defined as a business requirement that would need considerations across multiple architectural layers of a business application to address the requirement. Like for example: For a business application to operate in a self-service retail environment, there would be user layer (UI) considerations( like what functionality is accessible and what is not), business logic layer considerations ( like a wholesaler may get discounts that may not be applicable to retail marketing channel), the business process steps followed for a request coming from a teller in an e-banking application may be different from those coming from a user using internet self-service channel, integration layer considerations like the back-ends systems to integrate may be different and similarly persistence layer considerations may also be different.

“Variation” can be defined as a well defined architectural component that can be modified and applied to alter the behavior of an enterprise business application.

“Variation Point” is a well defined plug-in point in the architecture for the variation to be plugged in.

“Variation Bundle” can be defined as a mechanism provided to group a related set of variations within an architectural layer.

“Business Aspects” can be defined as a mechanism provided to group a set of related variation bundles across multiple architectural layers to address a cross-cutting business concern

The proposed inventive method Business Aspects Solution identifies the various variation points, variations at the various architectural layers of a typical enterprise business application. It also defines the mechanisms for bundling each of these variations as a group to enable better management.

To map to AOP terminology, the “Variation Points” are similar to PointCuts but the key difference is that Variation Points are much more coarse-grained that what are defined as PointCuts in AOP, similarly Variations are similar to Advice and “Variation Bundles” are similar to Join-Points and “Business Aspects” are similar to Aspects.

The inventive method identifies the common variation requirements for the common cross-cutting business concerns, and then identifies the architecture strategies to enable such variation and then, based on those strategies define architecture with well defined variation points and finally define mechanisms for bundling such variations.

In one embodiment of the present invention, it is described how to take this method to execution level by explaining how to develop a business aspects framework solution. And what is proposed is a solution for creating coarse-grained aspects that will make sense at business level—“Business Aspects” Solution.

The “Business Aspects” solution solves the problem by applying Aspect Orientation techniques at Architecture level. The proposed solution looks at the variations needed at the various characteristics of an enterprise application as cross cutting architectural concerns that cut across the various architectural layers and then applies Aspect Orientation techniques at Architecture level.

“Business Aspects” solution defines how to create Business Aspects for addressing cross-cutting architectural concerns. The proposed solution explains the design of various mechanisms needed to enable changes in application characteristics in different contexts including:

mechanisms for capturing the various decision parameters that influence changes in application characteristics through a “Context” component

the various Architectural “Variation Points” needed

the different Architectural “Variation” mechanisms

the “Architectural Variation bundling” mechanisms

mechanisms to associate different variation bundles to different contexts

and mechanisms to resolve and inject the variations based on currently active context

Following is the description of how “business aspects” can be developed for applying cross-cutting business concerns and how this inventive method enables creating context aware enterprise business applications through managed variations.

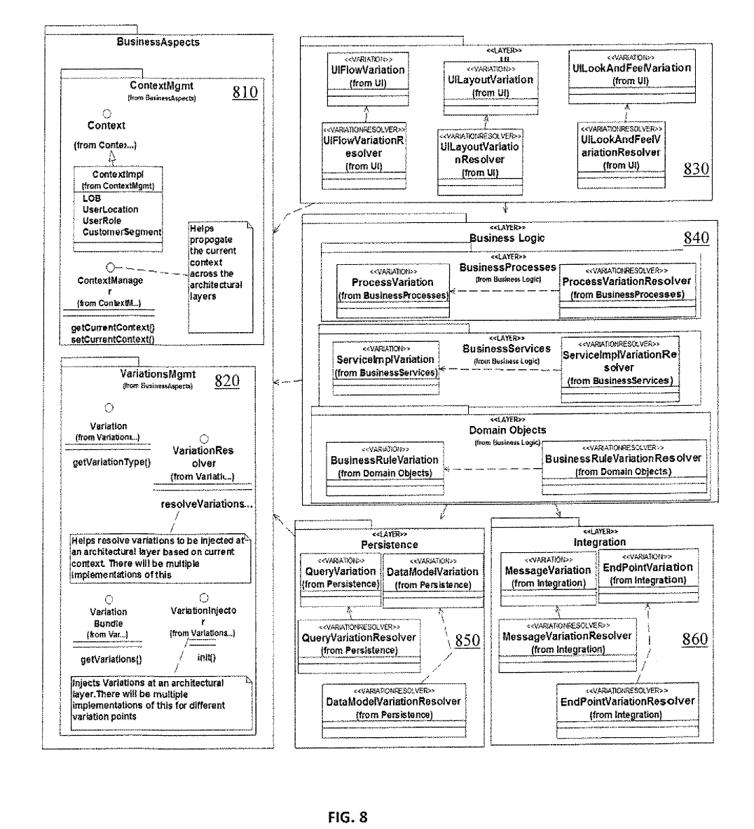

Referring to FIG. 8, it gives on overview of some of the key design elements for context and variations management along with a few illustrative architectural variation components at the various architectural layers.

Referring to FIG. 8, the Context design element 810 is used for capturing the various decision parameters. It is designed as an interface with a default implementation containing the common decision parameters like LOB where application is deployed, User Role, User Location, Customer Segment that User belongs to etc.

In FIG. 8, ContextManager design element 810 takes care of determining the current context and associating the current context to the current thread of execution along the various architectural layers of the application. It will also provide mechanisms for any architectural component at any layer to determine the current context. It needs to provide a mechanism for propagation of the context implicitly without having to require the various functional components to pass the context explicitly. It may use mechanisms like threadlocal storage for implementing this.

In FIG. 8, Variation design element 820 represents a Architectural Variation and there will be multiple implementations of this element as illustrated in the FIG. 8 like UIFlowVariation, UILayoutVariation etc in UI layer 830, ServicelmplementationVariation, BusinessRuleVariation etc in Business layer 840, QueryVariation etc in Persistence Layer 850, MessageVariation in Integration layer 860 and so on. VariationBundle design element 820 provides mechanisms for bundling related variations.

Referring to FIG. 8, the VariationResolver design element 820 is used to resolve variation bundles based on currently active context.

In FIG. 8, the VariationInjector design element 820 injects the architectural variation into the enterprise application.

To understand the proposed method, consider the following example.

Scenario: Customize how say “limits check” functionality is implemented in calculating transaction limits for financial transactions in an e-banking scenario based on the operating context (limits are different if the channel is self-service vs say through assisted channels like through teller)

Considerations & Pain Points: Monolithic service implementations make it difficult to modify specific request handling

Architecture Strategy: Design the Service implementations to use pluggable request handlers and design a mechanism that will plug in different request handlers based on the currently active context.

In another embodiment of the present invention, how different layers in architecture of an enterprise application framework will be designed based on the above examples is discussed here.

Business Logic Layer:

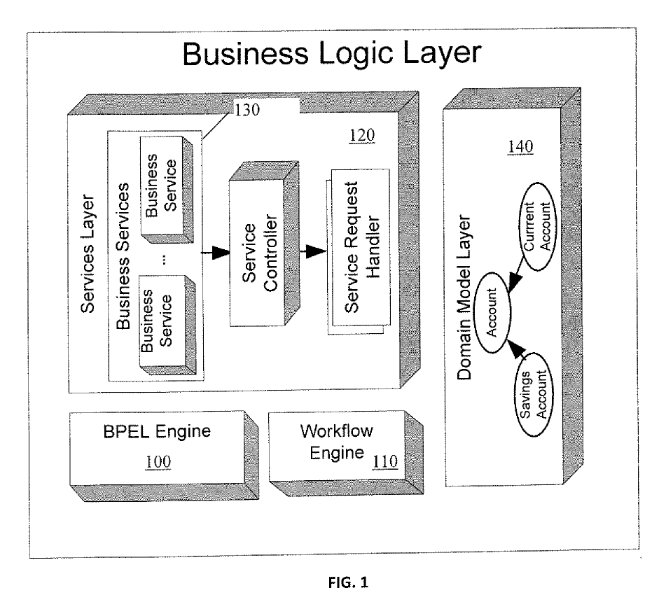

Referring to FIG. 1, it shows the recommended logical architecture for the business tier with the variation points and the mechanisms for bundling the variations together as a business aspect. The Table 1 below has the list of common scenarios and the architecture strategies for the Business Logic Layer in an enterprise application.

TABLE 1

| Scenario | Strategy |
|---|---|
| Vary service | Use Service Locator to lookup different Service |
| implementation | Implementations based on context |
| based on context | |
| Vary service request | Design Service implementation to use pluggable |
| handling logic | Service Request Handlers 120 |
| based on context | |
| Vary sequence of | Use Configurable BPEL engines 100 to model |
| steps in a business | service orchestrations |
| process involving | Define multiple processes for multiple business |
| service orchestrations | contexts 130 |
| based on context | Provide an indirection between logical process |
| | ID and actual process ID |
| Vary sequence in | Use Workflow engines 110 to model processes |
| processes | involving human interactions |
| involving human | Define multiple workflows for multiple contexts |
| interactions | Provide an indirection between the logical |
| based on context | workflow ID to the actual workflow ID |
| Vary business logic | Design business logic implementation to sue a |
| based on context | rules engine and provide mechanism to plug |
| | different rulesets based on configuration |
| | Design business logic implementation logic to |
| | be parameter driven and provide a service |
| | configuration mechanism |
| | Design the core business logic to be Object- |
| | Oriented and provide a mechanism to plugin |
| | different implementations based on |
| | configuration |
| Vary service | Interface driven services with technology |
| invocation | wrappers like EJB/JAX-RPC wrappers |
| mechanisms based | Configuration driven service implementation |
| on context | technology selection |

The recommended logical architecture for the business logic tier based on the strategies listed is shown in FIG. 1.

Architecture Strategies for Business Logic Layer:

Interface driven business services 130

Pluggable service request handlers 120

OO Domain Layer 140

BPEL 100 for macro process flows

XML driven request handler chaining for micro flows

Workflow engine 110 for process flows with human interaction

Variation Points and Variation Bundles for Business Logic Layer:

The Variation Points and the Variations mechanisms and the mechanisms for bundling the variations to create a business aspect for the business tier are shown below in a

TABLE 2

| VariationPoints | Variation | VariationBundle |
|---|---|---|
| (PointCut) | (Advice) | (JoinPoint/Aspect) |
| Service | Customized | An XML or similar configuration |
| Implementation | Service | mechanism with the mapping of |
| | Implementation | service names to Service |
| | | implementations |
| Service | Customized | An XML or similar configuration |
| Request | Service Request | mechanism with the combination |
| Handlers 120 | Handler 120 | of Handlers |
| Business | Customized | An XML or similar configuration |
| Processes | BPEL 100 | mechanism with the combination |
| 130 | Process | of Process IDs |
| Workflows 110 | Customized | An XML or similar configuration |
| | Workflow | mechanism with the combination |
| | | of Workflow IDs |
| Inheritance, | Inherited Object | Extended classes bundled as |
| Object Factory | | variations jar |
| Rules | Customized Rule | An XML or similar configuration |
| | | mechanism with the Rulesets |
| Parameterization | Customized | Service Configuration XML Files |
| | Parameter | or similar configuration |
| | | mechanism |

### Table 2.

User Interface Layer:

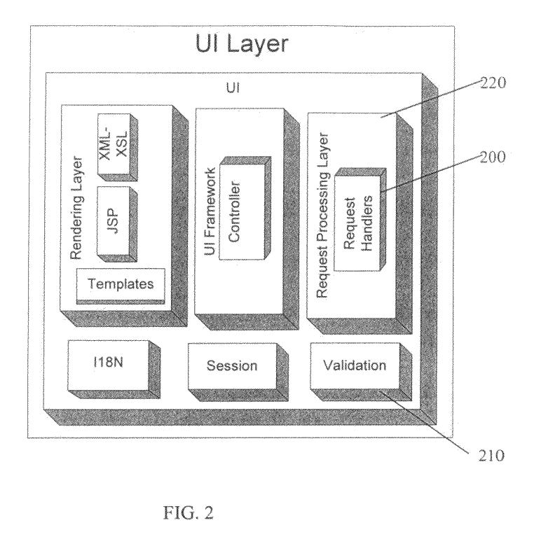

The recommended logical architecture for the UI Layer with the variation points and the mechanisms for bundling the variations together as a business aspect are shown in FIG. 2.

The Table 3 below has the list of common scenarios and the architecture strategies for the User Interface Layer in an enterprise application.

TABLE 3

| Scenario | Strategy |
|---|---|
| Vary View based on | Use MVC design with pluggable view layer |
| context | and with a config file defining all the views |
| Vary sequence in which | Use Configurable Screen flow logic and |
| the UI pages are pre- | provide a mechanism to define the various |
| sented based on context | screen flows through a config file |
| Vary the input | Use a configurable validations mechanism |
| validations | with support for defining the validations |
| based on context | required for all the screens |
| Vary request processing | Design a pluggable request processing layer |
| logic based on context | 220 with a config file defining all the handlers |
| | 200 for the various UI actions |
| Vary display text | Externalize the display text and provide a |
| based on context | mechanism for selecting different resource |
| | bundles as needed |

The recommended logical architecture for the UI layer based on the strategies listed is shown below and also in FIG. 2.

Architecture Strategies for UI Layer:

MVC with pluggable view layer

Configurable screen flow

Pluggable input validations 210

Resource bundles for display text

Pluggable UI request handlers 200

Variation Points and Variation Bundles for UI Layer:

The Variation Points and the Variations mechanisms and the mechanisms for bundling the variations to create a business aspect for the business tier are shown below in Table 4.

TABLE 4

| VariationPoints | Variation | VariationBundle |
|---|---|---|
| (PointCut) | (Advice) | (JoinPoint/Aspect) |
| View layer | Customized View | An XML or similar |
| | | configuration mechanism with |
| | | the combination of Views |
| Request | Customized | An XML or similar |
| Processing | UI Request | configuration mechanism with |
| Layer 220 | Handler 200 | the combination of Request |
| | | handlers |
| Input | Customized Validator | An XML or similar |
| Validations | | configuration mechanism with |
| 210 | | the combination of Input |
| | | Validators mapped to UI |
| | | elements |
| Display text | Customized UI | Resource Bundle with the text |
| | Display Text | messages |
| | message | |
| UIScreenFlow | Customized UI | An XML or similar |
| | Flow for a | configuration mechanism with |
| | UI request | the combination of the UI screen |
| | | flow rules |

Integration Layer:

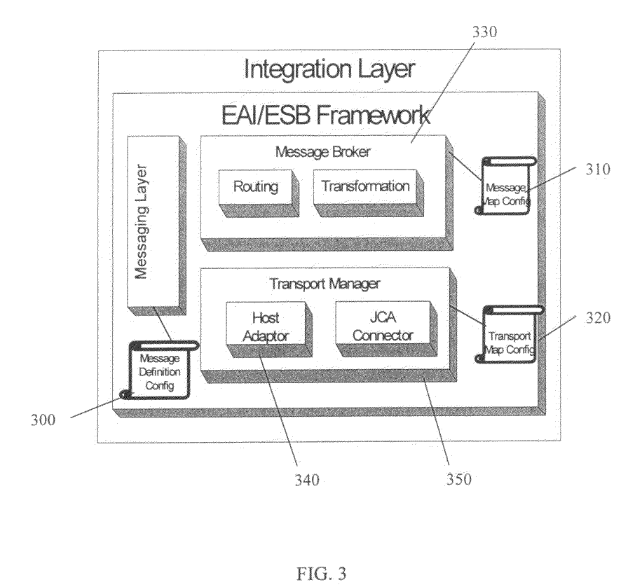

The recommended logical architecture for the Integration Layer with the variation points and the mechanisms for bundling the variations together as a business aspect are shown below and in FIG. 3.

The Table 5 below has the list of common scenarios and the architecture strategies for the integration layer in an enterprise application.

TABLE 5

| Scenario | Strategy |
|---|---|
| Vary back-end host | Configurable message definition 300 |
| message formats based | Configurable mapping to back-end message |
| on context | formats 310 |
| Vary back-end host | Configurable Transport Layer 320 with |
| communication protocol | pluggable host adaptors 340. |
| based on context | |
| Vary back-end host | Configuration driven integration framework |
| selected for | for back-end integration. |
| integration based | Configurable Message broker 330 with config |
| on context | driven message routing and transformation |

The recommended logical architecture for the Integration layer based on the strategies listed is shown below and in FIG. 3.

Architecture Strategies for Integration Layer:

Configurable message definition 300 and message mapping 310

Configurable message routing and transformation 330

Configurable communication protocols with pluggable adaptors 350

Variation Points and Variation Bundles for Integration Layer:

The Variation Points and the Variations mechanisms and the mechanisms for bundling the variations to create a business aspect for the integration layer are shown below in Table 6.

TABLE 6

| VariationPoints | Variation | VariationBundle |
|---|---|---|
| (PointCut) | (Advice) | (JoinPoint/Aspect) |
| Communication | Customized | An XML with the |
| mechanism | Transport | combination of host |
| | Adaptor 350 | adaptors plugged in. |
| Message Formats | Customized Message | An XML with the message |
| | Definitions 300 and | definitions and maps for |
| | Message Maps 310 | message transformations |
| Message Routing | Customized Message | An XML with the message |
| 330 | routing | routing rules. |

Data Layer:

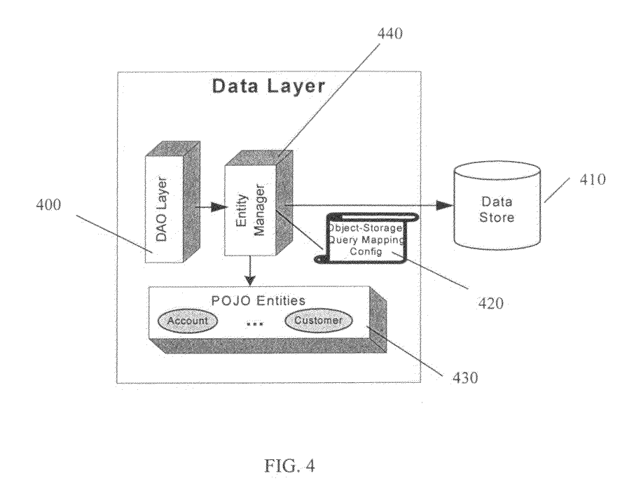

The recommended logical architecture for the Data Layer with the variation points and the mechanisms for bundling the variations together as a business aspect are shown below and also in FIG. 4.

The Table 7 below has the list of common scenarios and the architecture strategies for the Data Layer in an enterprise application.

TABLE 7

| Scenario | Strategy |
|---|---|
| Vary underlying | Use interface driven DAO 400 design with |
| storage mechanism | configurable mapping 420 between the DAOs |
| based on | 400 to storage mechanism underneath with |
| context | support for like different mechanisms like |
| | RDBMS, File etc. |
| | Use a config file to define such mappings |
| | between the DAOS 400 and the storage |
| | mechanisms 410. |
| Vary underlying | Use configurable mapping (like O-R mapping) |
| structure of the | from the Objects used in system to the |
| data storage | representations in the underlying storage with |
| based on context | a config file defining the mapping 420. |
| | Design the Objects representing the data to be |
| | extensible |

The recommended logical architecture for the Data layer based on the strategies listed is shown below and also in FIG. 4.

Architecture Strategies for Data Layer:

Interface driven DAOs 400

Configurable Data Storage Mechanism 410

Configurable mapping between Objects and storage representations 420

Externalized and configurable queries

Extensible Entity objects 430

Variation Points and Variation Bundles for Data Layer:

The Variation Points and the Variations mechanisms and the mechanisms for bundling the variations to create a business aspect for the data layer are shown below in Table 8.

TABLE 8

| VariationPoints | Variation | VariationBundle |
|---|---|---|
| (PointCut) | (Advice) | (JoinPoint/Aspect) |
| Persistence logic | Customized | An XML with the combination |
| | DAO 400 | of DAOs, Queries and Object- |
| | | Storage representation mapping |
| Storage Mechanism | Customized | An XML with the DAO to entity |
| Selection | EntityManager | manager mapping |
| | 440 | |
| Query Mapping 420 | Customized | An XML with the query |
| | Query Mapping | configuration |
| Entity Objects 430 | Inherited and | An XML with the Object |
| | customized | definition and the combination |
| | entity objects | of Entity objects |

Proposed Solution Execution:

Following is the description of how “business aspects” can be developed for applying cross-cutting business concerns using the Infosys RADIEN Framework. And it also explains how this solution which is based on inventive method enables creating context aware enterprise business applications through managed variations.

In one embodiment, the variations problem and the design solution to address the problem have been described. The next step is to develop a framework that enables defining and implementing business aspects through managed variations.

In another embodiment, the various variation points along with the variation mechanisms and variation bundling mechanisms required at the various tiers have been identified. Implementing this would require an application framework with the variation points. The implementation framework for the business aspects in J2EE is the RADIEN Framework that has been designed and developed incorporating all these variation points.

The implementation specifics for some of the key variation points in RADIEN are described below. RADIEN Framework consists of several sub-frameworks for the various tiers and they are designed to incorporate the variations points of the corresponding layer.

Business Logic Layer:

The various variation points of the Business logic layer along with the variation mechanism and the variation bundling mechanisms are described below.

Service Implementation Variation:

RADIEN services framework provides the components for lookup and use service instances and is the core to plugging in variations based on context. It is interface driven and allows different service implementations to be plugged in.

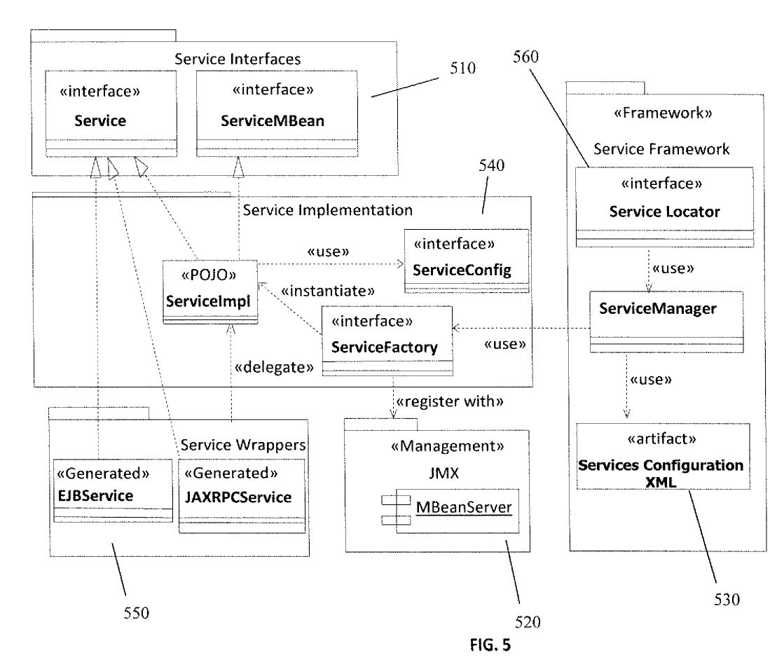

The UML model in FIG. 5 shows the service framework components.

Let's take a scenario where a Business Service named say PaymentService needs to be developed. The following steps describe how to define, develop, configure and use the service through the RADIEN services framework and how to plug-in variations through different service implementation based on context and how to group/bundle such variations for a given context.

Step 1: A functional interface is defined for the service 510 as say

```
public interface PaymentService {
    public void makePayment(PaymentDTO PaymentDTO) throws
    PaymentServiceException, RemoteException;
}
```

Step 2: A management interface 520 is defined for the service as say

public interface PaymentServiceImplMBean extends ServiceMBean {
public int getProcessedPaymentCount( );
}

Step 3: The service functional and management interfaces are implemented and the service instance is configured with a logical service name in RADIENServiceConfig.xml 530 as shown below.

For a simple Java POJO implementation 540 it's configured as shown below.

```
<RADIENServiceConfig>
  <ServicesConfig>
    <ServiceConfig>
      <ServiceName>PaymentService</ServiceName>
<ClassName>com.infosys.bankaway.Payment.service.impl.-
RetailPaymentServiceImpl</ClassName>
<FactoryClassName>com.infosys.j2ee.core.impl.GenericServiceFactory</
FactoryClassName>
      <ParamMap>
        <Param name=“default-limit” value=“1000”/>
      </ParamMap>
    </ServiceConfig>
...
  </ServicesConfig>
</RADIENServiceConfig>
```

To plug-in variations of the service implementations 540 by changing the ClassName parameter which is used to specify the implementation class.

There is a similar configuration mechanism for an EJB/WebService 550 based implementations with capabilities to vary implementations.

The usage code as shown below is tied only to the logical name of the service and the functional interface and so allows different implementations to be plugged in.

//Look up payment service using a name
PaymentService paymentServiceInstance =(PaymentService)
RADIENServiceLocator.getInstance( ).getService(“PaymentService”);
//use payment service through functional interface
paymentServiceInstance.makePayment(PaymentDTO);

The RADIEN Service Config XML 530 thus provides a variation point to plug in different service implementations based on context. The service locator 560 provides an appropriate service implementation 540 instance for a given logical name based on context. The RADIEN Service Config XML 530 also provides the variation bundling mechanism to group the service implementations 540 related to a context. Like for example all service implementation 540 instances for a particular context say an LOB can be defined in one RADIEN Service Config XML 530 and those for another LOB in another RADIEN Service Config XML 530 and so on.

Service Request Handler Variation:

Another variation mechanism is service request handler mechanism. A common requirement is to vary how a service request is handled based on context for some requests while the request handling logic for most other requests is same across different contexts. Service implementation variations mechanism described above can be used for this but that could result in duplication of the logic across the different implementations. A better solution is to provide pluggable service request handlers and then enable different request handlers to be plugged in based on context.

To address these requirements, a service in implemented in terms of service requests and service request handlers with a service controller having a map of requests to handlers.

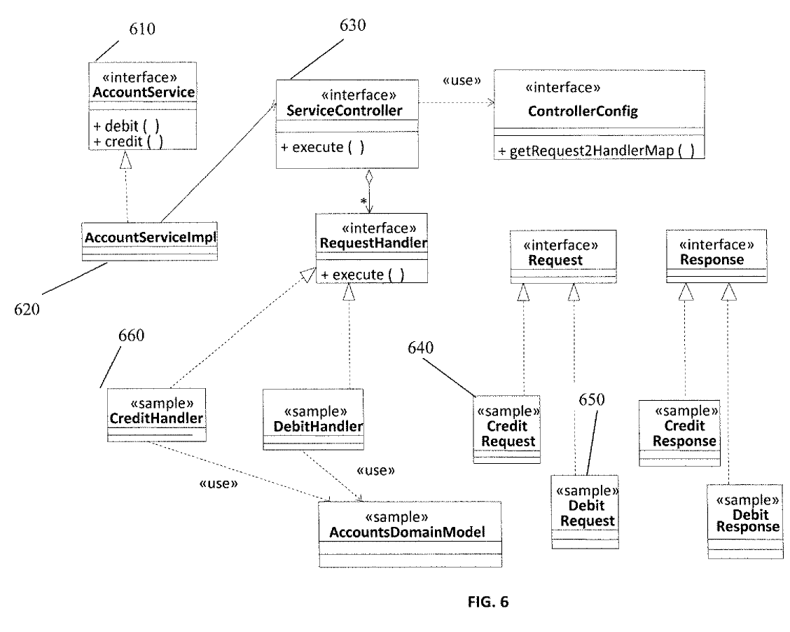

The UML model in FIG. 6 shows the various design elements of this architecture for a sample AccountService.

Referring to FIG. 6, the AccountService 610 interface is implemented through an AccountServiceImpl 620 class which uses a service controller 630 underneath. The service controller 630 is driven a configuration as shown below which maps credit 640 and debit requests 650 to the corresponding handlers. Now, how a credit request 640 for example is handled by the service implementation can be varied individually by plugging in different credit request handlers 660.

```
<controller>
  ...
  <request requestName=“CreditRequest”>
    <request-handler name=“CreditRequestHandler” seq-no=“1”>
      <handler-
class>com.infosys.bankaway.account.service.impl.handlers.-
CreditRequestHandler</handler-class>
    </request-handler>
  </request>
  <request requestName=“DebitRequest”>
    <request-handler name=“DebitRequestHandler” seq-no=“1”>
      <handler-
class>com.infosys.bankaway.account.service.impl.handlers.-
DebitRequestHandler</handler-class>
    </request-handler>
  </request>
  ...
</controller>
```

Referring to FIG. 6, the service controller framework thus provides the service request handler variation point and the controller configuration XML provides a mechanism to bundle the request handlers belonging to a particular context as a variation bundle.

Object Inheritance Variation:

Another variation mechanism available is Object inheritance mechanism.

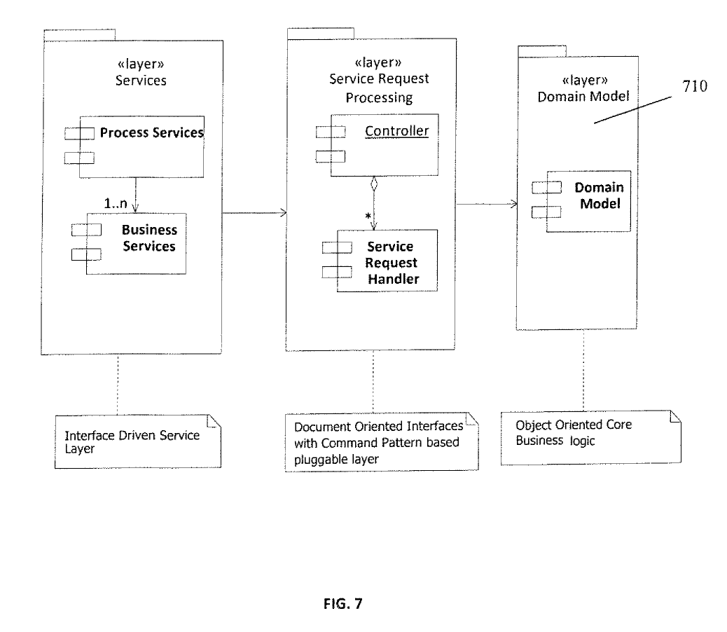

As shown in the UML model in FIG. 7, the core business logic layer is implemented using an Object Oriented Domain Model layer 710.

RADIEN leverages Spring for the OO (Domain Model) Layer implementation. The objects are configured with a logical name as beans and the dependencies among the objects are defined in the spring configuration XML as shown below.

```
<beans>
...
  <bean id=“Payee” class=“com.infosys.setlbank.payee.domain.Payee”>
      <property name=“billPayment”><ref
      bean=“BillPayment”/></property>
  </bean>
  <bean id=“BillPayment” class=“com.infosys.setlbank.payee.-
  domain.BillPayment”/>
...
</beans>
```

This allows the domain model 710 objects to be sub classed for any context specific variations and to be plugged in by modifying this XML This spring configuration XML thus helps to bundle the variations based on object inheritance.

Workflow, Business Process and Rule Variation:

Variation mechanism for Business processes, Workflows and Business Rules are explained below.

The business processes which are service orchestration based are modeled using a COTS BPEL engine like OracleBPEL engine or IBM BPWS4J engine etc and these engines are leveraged to define multiple processes for multiple contexts. Similarly, business processes involving human interactions with manual and automated steps are modeled using a COTS Workflow engine like Staffware engine or JBPM engine etc and these engines are leveraged to define multiple workflows for multiple contexts. Business reules are externalized using COTS Rule engines like Drools, ILOG JRules etc. This enables varying the rules for different contexts. A layer of indirection is provided over these BPEL, Workflow and Rule engines through adaptors which provide a mapping of logical workflow IDs to the actual workflow IDs, logical BPEL process ID to actual BPEL process ID and similarly logical RuleSet IDs to actual RuleSet IDs. These adaptors are XML configuration driven which provides the mechanism for bundling the Workflow/BPEL Process/Rule variations related to a context. The Table 9 below provides the summary of the various Business Logic layer variations in RADIEN.

TABLE 9

| VariationPoints | Variation | VariationBundle |
|---|---|---|
| (PointCut) | (Advice) | (JoinPoint/Aspect) |
| Service | Customized Service | RADIEN Service Config XML |
| Implementation | Implementation | |
| Service Request | Customized Service | RADIEN Service Controller |
| Handlers | Request Handler | XML |
| Business | Customized | RADIEN Process Config XML |
| Processes | BPEL Process | |
| Workflows | Customized | RADIEN Workflow Config |
| | Workflow | XML |
| Inheritance, | Inherited Object | Extended classes bundled as |
| Object Factory | | variations jar |
| Rules | Customized Rule | An XML with the Rulesets |
| Parameterization | Customized | RADIEN Service Config XML |
| | Parameter | |

User Interface (UI) Layer:

RADIEN framework offers multiple implementation choices for the presentation tier. The default implementation choice for UI is based on Apache Struts framework. The various variation points of the UI layer based on the default framework along with the variation mechanism and the variation bundling mechanisms are described below.

View Layer Variations:

The UI Layer Views (in the MVC) are defined using a component based framework like tiles. The views are defined as a composition of reusable UI components using a templating mechanism as shown below. This enables the UI components to be customized based on context and also to change the composition of the components in a view based on context and thus provides variation mechanisms in the view layer. The View definitions are defined using an XML (like TilesDefintion.XML) which helps bundle the view layer variations belonging to a context.

```
<component-definitions>
...
  <definition name=“View-1” path=“/view-1.jsp”>
    <put name=“header” value=“/header.jsp”/>
    <put name=“footer” value=“/footer.jsp”/>
    <put name=“body” value=“/view-1Body.jsp”/>
  </definition>
---
</component-definitions>
```

UI Request Processing Layer Variations:

The UI request processing is performed through a central controller with pluggable UI request handlers. For struts based implementation, the request handlers are Struts Action classes and the controller is the Struts Controller Servlet. UI Request to handler mapping is configurable and for Struts based implementation, the request to handler mapping and the routing to appropriate views based on the result of the request handling is configured in StrutsConfig xml as shown below. This enables plugging different request handlers for different contexts and the struts config xml provides the mechanism for bundling related handlers.

```
<action-mappings>
...
  <action name=“request1Form” type=“com.infosys.setlbank.-
  Request1Action”
    input=“/request1.jsp” scope=“request” path=“/request1”>
    <forward name=“success” path=“success.jsp” />
    <forward name=“failure” path=“/error.jsp” />
  </action>
...
<action-mappings>
```

UI Input Data Validation Variations:

UI input validation is another common place for variations based on context. To enable easy plugging in of different validations, RADIEN leverages the apache commons validation framework. The validations XML provide the mechanism for defining the validations and for grouping the validations. For struts based implementations, the validation rules are plugged in through the plug-in configuration in Struts Config XML as shown below.

```
<plug-in className=“org.apache.struts.validator.ValidatorPlugIn”>
  <set-property property=“pathName” value=“/WEB-INF/validator-
  rules.xml” />
</plug-in>
```

UI Display Data Variations:

Another common variation point in the UI layer is the messages displayed to the user in the views. To enable variation of the messages displayed in the views based on context, the messages are externalized from the views and are plugged in through ResourceBundle mechanisms. For struts based implementations, the message resource configuration in the Struts Config XML is used to plugin the resource bundles corresponding to a context as shown below. The resource bundle property file provides the mechanism for bundling the message variations of a context.

<message-resources parameter=“con.infosyssetlbank.ApplicationResources”/>
The Table 10 below provides the summary of the various User Interface (UI) layer variations in RADIEN

TABLE 10

| VariationPoints | Variation | VariationBundle |
|---|---|---|
| (PointCut) | (Advice) | (JoinPoint/Aspect) |
| View layer | Customized JSP and | Tiles Definition xml |
| | View definition in | |
| Request Pro- | Customized Struts | Strutsconfig.xml |
| cessing Layer | Action Class | |
| Input | Customized | Validator.xml |
| Validations | Validator | |
| Display text | Customized UI | ApplicationResources.properties |
| | Display Text message | |

Integration Layer:

Message Variations:

Another variation mechanism available in the integration layer is the Message variation which is explained below.

A common requirement for variations in the integration layer is in the structure of the messages used to communicate with the external system.

RADIEN provides a XML configuration driven mechanism for message definition along with the mapping of the internal object structures to the external message structures similar to the entity object to table mapping described earlier. This XML enables defining the variations and also in bundling the related variations based on context.

Message Routing Variations:

Another common requirement for variations in the integration layer is in the routing of the messages to different external systems based on context.

RADIEN integration framework includes a message broker which routes messages to different systems based on a XML configuration. This XML enables Message Routing Variations to be defined and also to bundle related routing variations.

Transport/Communication Variations:

Another common requirement for variations in the integration layer is in the transport/communication mechanism used in interfacing with external systems based on context.

RADIEN integration framework includes an interface driven transport layer that allows different transport implementations to be plugged in based on a XML configuration. This XML enables Transport Variations to be defined and also to bundle related transport variations.

The Table 11 below provides the summary of the various Integration layer variations in RADIEN.

TABLE 11

| VariationPoints | Variation | VariationBundle |
|---|---|---|
| (PointCut) | (Advice) | (JoinPoint/Aspect) |
| Message Formats | Customized Message | MessageMap.xml |
| | Definitions and Message | |
| | Maps | |
| Message Routing | Customized Message | MessageBrokerConfig.xml |
| | routing | |
| Communication | Customized Transport | TransportConfig.xml |
| mechanism | Adaptor | |

Data Layer:

Persistence Logic & Storage Mechanism Variations:

The first variation mechanism available in the data layer is the persistence logic implementation variation which is explained below.

RADIEN framework provides a persistence framework with a configuration driven mechanism that enables different persistence implementations to be plugged in.

With RADIEN, the persistence logic is implemented using DAO (Data Access Object) design pattern and is interface driven. The usage code is in terms of the DAO interface and the implementations are looked up using a logical name as shown below. This enables different implementations of the persistence logic implementations sticking to the DAO interface to be plugged in easily through configuration changes.

//Look up the DAO Service
DAOService daoService = (DAOService)
RADIENServiceLocator.getInstance( ).getService(“SetlBankDAO-
Service”);
//Look up the DAO
AccountDAO accountDao = (AccountDAO) daoService.-
getDAO(“AccountDAO”);
//Use the DAO interface
accountDao.createAccount(accountVO;

A DAO Config XML configuration driven mechanism is used to enable plugging in different DAO implementations as shown below with a mapping of the DAO logical name to the implementation details. This DAO Config XML provides the mechanism for bundling the persistence logic implementation based variations for a context.

```
<DAOConfig>
...
  <GenericDAO>
    <DAOName>PersondetailDAO</DAOName>
<DAOClassName>com.infosys.j2ee.persondetail.dao.-
PersondetailDAOImpl</DAOClassName>
...
  </GenericDAO>
...
</DAOConfig>
```

Query Variations:

Another variation mechanism available in the data layer is the query variation which is explained below.

Persistence logic for a request especially for a RDBMS datastore usually involves the following 3 steps:

1) Create a Query

2) Update query with values from the input request objects

3) Execute query and create response objects from the ResultSet

To enable easy variation of persistence logic for a particular request, RADIEN persistence framework provides a XML driven configuration mechanism that enables defining the Query to be used, then mapping of request object fields to place holders in the query and finally mapping of the resultset values to response objects as shown below. This provides a mechanism to vary the query or the input request object structure or the output response object structure through changes to this XML and this XML also enables bundling related variations for a context.

```
<GenericDAO>
  <DAOName>JointAccountsDAO</DAOName>
  <DAOClassName>com.infosys.bankaway.common.dbaccess.-
  FinacleGenericDAO</DAOClassName>
    <Query name=“JointAccounts_QUERY_1” sql=“ SELECT
XYZ.BANK_ID , ... , XYZ.INT_RATE FROM XYZ,CLOC WHERE ”>
      <QueryDynaPartMap>
        <QueryDynaPart dyna-part=“ CLOC.BANK_ID =
        #cloc.bankId# ”/>
        ...
        <QueryDynaPart dyna-part=“ AND XYZ.ac_stat = ‘001’ ”>
            <Condition append-type=“AND” operator =“EQUALS”>
              <LValue data-type=“java.lang.Boolean” expr-type=
  “PARAM” expr-value=“closedAccounts”/>
              <RValue data-type=“java.lang.Boolean”
  expr-type=“CONSTANT” expr-value=“FALSE”/>
            </Condition>
        </QueryDynaPart>
        ...
      </QueryDynaPartMap>
      <QueryParamMap vo-
  classname=“com.infosys.bankaway.user.dbaccess.JointAccountsCrit”>
        <ParamInfo name=“cloc.bankId” sql-type=“STRING”
        length=“9”/>
        <ParamInfo name=“closedAccounts” sql-type=“BOOLEAN”
        length=“1”/>
      </QueryParamMap>
      <ResultSetMap vo-classname=“com.infosys.bankaway.user.-
      dbaccess.JointAccountsData”>
        <ParamInfo pos=“1” name=“XYZ.bankId”
        sql-type=“STRING”/>
        <ParamInfo pos=“2” name=“XYZ.branchId”
        sql-type=“STRING”/>
        ...
        <ParamInfo pos=“15” name=“XYZ.intRate”
        sql-type=“DOUBLE”/>
      </ResultSetMap>
      </Query>
  ...
</GenericDAO>
```

Entity/DTO Variations:

Another variation mechanism available in the data layer is the Entity Object variation which is explained below.

A common requirement for variations in the data layer pertain to the structure of the entity objects and the data transfer objects (input/outputs to the data layer) in terms of need for more fields to an entity or other such changes. These changes result in further changes in the mapping of the entity fields to the transfer objects and the mapping to the underlying data store structures like say tables in case of RDBMS data stores.

RADIEN provides the following variation points for these:

Extensible Entity/DTOs based on Map data structures

XML driven Object to Object mapping mechanism

Query mapping mechanism explained above for entity object fields to table columns

The Table 12 below provides the summary of the various Data layer variations in RADIEN.

TABLE 12

| VariationPoints | Variation | VariationBundle |
|---|---|---|
| (PointCut) | (Advice) | (JoinPoint/Aspect) |
| Entity Objects | Inherited | Object Definition XML and |
| | and customized | Object to Object Mapping XML |
| | entity objects | |
| Persistence logic | Customized DAO | DAO Config XML |
| Storage Mechanism | Customized | DAO Config XML |
| Selection | EntityManager | |
| Query Mapping | Customized | An XML with the query |
| | Query Mapping | configuration |

The proposed solution can be applied to create context aware business applications. This solution can be applied for creating context aware enterprise business services as well as context aware enterprise business processes. The behavior of the services or processes or entire business application can be varied based on context through the variations that are plugged in at static pre-compilation stage or at runtime. These variations can be managed effectively through the variation bundling mechanisms. This enables creating shared services and processes across multiple Lines of Business (LOBs), organizations, regions within an enterprise. Like for example, this solution can be leveraged to create an enterprise shared business service for say insurance premium calculation that can be used in multiple context like different LOBs like property, auto etc and also across multiple regions like different states or countries etc. Since the variations are plugged in, it enables true sharing of the commonalities across the multiple LOBs, regions in the shared service through a common skeleton and externalized variations.

Thus, the problem with unmanaged variations and the proposed solution to address the challenges down to the implementation details are described and discussed. This solution enables creating context aware services and applications with managed variations defined as business aspects. This solution can be further enhanced to handle more architectural styles.

Exemplary Computing Environment

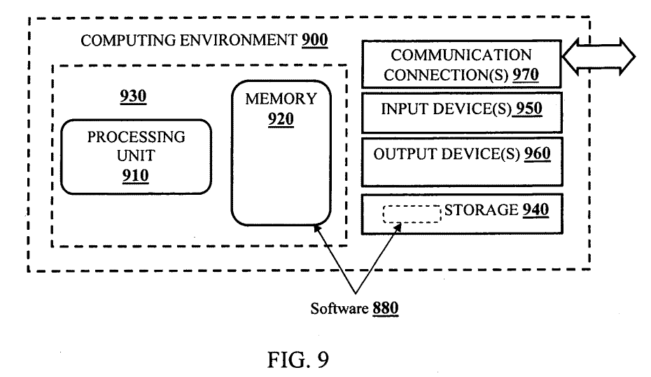

One or more of the above-described techniques may be implemented in or involve one or more computer systems. FIG. 9 illustrates a generalized example of a computing environment 900. The computing environment 900 is not intended to suggest any limitation as to scope of use or functionality of described embodiments.

With reference to FIG. 9, the computing environment 900 includes at least one processing unit 910 and memory 920. In FIG. 9, this most basic configuration 930 is included within a dashed line. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. In some embodiments, the memory 920 stores software 980 implementing described techniques.

A computing environment may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other medium which may be used to store information and which may be accessed within the computing environment 900. In some embodiments, the storage 940 stores instructions for the software 980.

The input device(s) 950 may be a touch input device such as a keyboard, mouse, pen, trackball, touch screen, or game controller, a voice input device, a scanning device, a digital camera, or another device that provides input to the computing environment 900. The output device(s) 960 may be a display, printer, speaker, or another device that provides output from the computing environment 900.

The communication connection(s) 970 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 900, computer-readable media include memory 920, storage 940, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

1. A method for handling at least one multi business concern at a business level while developing enterprise application, the method comprising:
identifying a plurality of common variation requirements for the at least one multi business concern;
identifying at least one decision parameter that determines the usage context and accordingly the variations needed for at least one multi business concern
identifying at least one architectural strategies to enable identified variation requirements;
defining an architecture of the enterprise application based on the identified strategies indicative of a plurality of defined variation points;
defining mechanisms for bundling the identified variations in a group to enable handling at least one multi business concern at a business level;
defining mechanisms for associating the variation bundles to plurality of usage contexts that will enable contextualizing the enterprise application characteristics to different contexts;
defining mechanisms for determination and propagation of context across the architectural layers of the enterprise application implicitly and injecting the variations based on the context and the configuration of the variation bundles to the plurality of contexts; and
defining the design of application framework will implementations of the plurality of variation points, variation mechanisms, variation bundles and mappings to plurality of contexts.

2. The method as recited in claim 1, wherein the variation is a well defined architectural component that can be modified to alter the behavior of an enterprise application or business application.

3. The method as recited in claim 1, wherein the variation point is a well defined plug-in point in the architecture of an enterprise application for the variation to be plugged in.

4. The method as recited in claim 1, wherein the variation bundle is a group of related set of variations within an architectural layer of an enterprise application.

5. The method as recited in claim 1, wherein context is one or more parameters like the Line Of Business (LOB) where the application is used and User Profile information like the user role, locale, language preference that determines the usage context.

6. The method as recited in claim 1, further comprising a mechanism to associate different variation bundles to different contexts.

7. The method as recited in claim 1, further comprising architecting an enterprise application to enable its characteristics to be contextualized based on combination of parameters like the Line Of Business (LOB) where the application is used and User Profile information like the user role, locale, language preference.

8. The method as recited in claim 1, further comprising architecting an enterprise application to contextualize the various characteristics like the user interface (UI), behavior, data model and the data store representations, integrations with external systems based on the context under which the application is used.

9. The method as recited in claim 8, wherein user interface (UI) of an enterprise application includes look and feel, layout of UI widgets, screen-flow or combinations thereof.

10. The method as recited in claim 8, wherein behavior of an enterprise application includes business rules applied, business logic implementations, service orchestration sequences, business processes followed or combination thereof.

11. The method as recited in claim 1, further comprising mechanisms for determining the context and propagating the context across the various architecture layers.

12. The method as recited in claim 1, further comprising mechanisms for injecting the different variations at the various architecture layers based on the current context using the configuration of the variations, variation bundles and mapping of the variation bundles to the contexts.

13. The method as recited in claim 1, further comprising the design of an application framework that provides implementations of the various variation points, variation mechanisms, variation bundling mechanism, mechanisms for mapping of the variation bundles to the contexts, mechanisms for context determination and propagation and mechanisms for injecting the variations based on current context of application usage.

14. The method as recited in claim 1, further enables developing context aware business enterprise applications.

15. A computer program product comprising a computer usable medium having a computer readable program code embodied therein for handling at least one multi business concern at a business level while developing enterprise application, the method comprising:
program code adapted for identifying a plurality of common variation requirements for the at least one multi business concern;
program code adapted for identifying at least one decision parameter that determines the usage context and accordingly the variations needed for at least one multi business concern
program code adapted for identifying at least one architectural strategies to enable identified variation requirements;
program code adapted for defining architecture of the enterprise application based on the identified strategies indicative of a plurality of defined variation points;
program code adapted for defining mechanisms for bundling the identified variations in a group to enable handling at least one multi business concern at a business level;
program code adapted for defining mechanisms for associating the variation bundles to plurality of usage contexts that will enable contextualizing the enterprise application characteristics to different contexts;
program code adapted for defining mechanisms for determination and propagation of context across the architectural layers of the enterprise application implicitly and injecting the variations based on the context and the configuration of the variation bundles to the plurality of contexts; and
program code adapted for defining the design of application framework will implementations of the plurality of variation points, variation mechanisms, variation bundles and mappings to plurality of contexts.
